(19) United States
(12) Patent Application Publication
(10) Pub. No.: US 2023/0003375 A1
(43) Pub. Date: Jan. 5, 2023

(54) WATERPROOF SPLICED BASE AND STAGE LIGHT FIXTURE WITH SAME

(71) Applicant: Guangzhou Haoyang Electronic Co., Ltd., Pan Yu, (CN)

(72) Inventor: Weikai JIANG, Pan Yu Guangzhou (CN)

(21) Appl. No.: 17/898,764

(22) Filed: Aug. 30, 2022

Related U.S. Application Data
(63) Continuation of application No. PCT/CN2021/143914, filed on Dec. 31, 2021.

(30) Foreign Application Priority Data
Jun. 30, 2021 (CN) 202121466420.0

(51) Int. Cl. F21V 31/00; F21V 21/26

(52) U.S. Cl. CPC F21V 31/005; F21V 21/26; F21W 2131/406

(57) ABSTRACT

A waterproof spliced base includes a top plate and a bottom plate oppositely arranged, and a plurality of side plates arranged around the periphery of the bottom plate and the top plate. The bottom plate, the top plate and the side plates are spliced together to form an accommodating cavity for accommodating electronic components. The top plate is provided with a pivoting hole for mounting a pivoting shaft of the stage light fixture. At least one sealing rubber strip for sealing the accommodating cavity are arranged between the side plates and the bottom plate as well as between the side plates and the top plate. Versatility of the components of the base in such configuration is much higher according to the present invention, and the base can be easily sealed with sealing rubber strips to ensure waterproof performance of the base.

### CROSS REFERENCE TO RELATED APPLICATIONS

The present application is a continuation of International Application No. PCT/CN2021/143914, filed on Dec. 31, 2021, which claims priority from Chinese Patent Application No. 202121466420.0 filed on Jun. 30, 2021, all of which are hereby incorporated herein by reference.

### TECHNICAL FIELD

The present invention relates to the technical field of stage light fixtures, and more particularly, relates to a waterproof spliced base and a stage light fixture with the same.

### BACKGROUND

A stage light fixture generally includes a base, a support arm pivoted to the base, and a light head pivoted to the support arm. Circuit components, such as a power switch, a transformer and a drive board, are mainly mounted in the base, thus requiring strict waterproof performance to the base. In order to achieve waterproof performance, base in the existing stage light fixtures is mostly in form of a cylinder with two openings at each end forming by stretching of aluminum material. The two openings are respectively sealed by two plates to achieve sealing of the base. However, such method for forming the base is high in cost, and inconvenient in disassembling and assembling, and may cause poor universality of the cylinder and two plates when designing base in different types, components thus cannot be shared according to actual requirements.

### SUMMARY

The present invention thus provides a waterproof spliced base and a stage light fixture with the base, which is free from the above-mentioned defects. The base according to the present invention is made of plates which is easy to be processed and ensures sealability of the base.

According to the present invention, the waterproof spliced base includes a top plate and a bottom plate arranged opposite to each other, and a plurality of side plates arranged around the periphery of the bottom plate and the top plate. The top plate, the bottom plate and the side plates are spliced together to form an accommodating cavity for accommodating electronic components. At least one sealing rubber strip for sealing the accommodating cavity is arranged between the side plate and the bottom plate as well as between the side plates and the top plate. The top plate is provided with a pivoting hole for mounting a pivoting shaft of the stage light.

The base according to the present invention is spliced by the top plate, the bottom plate and the side plates, which has advantages of convenience to disassemble and assemble and low manufacturing cost. Due to the splicing configuration, for bases in different types, only components of the base with size changed are required to be replaced, while other components of the base are in the existing designed specifications. For example, when bases with different height are in need, it is only required to change the height of the side plate, while changes for the top plate and the bottom plate are not necessary. When only changes for the length or width of the base are in need, the side plates in the width or length direction can remain for reuse. Therefore, versatility of the components of the base in such configuration is much higher, and the base can be easily sealed with sealing rubber strips to ensure waterproof performance of the base.

According to at least one embodiment, at least one side plate is provided with a signal interface for signal input and at least one side plate is provided with a display screen for information display.

According to at least one embodiment, the top plate, the bottom plate, and the side plates are all in form of profile plates. That is, the plates are formed by extrusion-drawing, die-casting or injection molding, which have high strength, can locally increase the thickness or make modeling, and can be conveniently spliced with other components or used for engaged with other components.

According to at least one embodiment, the side plates are fastened with the top plate 110 and the bottom plate 120 by screws. The screws are located outside the sealing rubber strip to avoid destroying sealability of the accommodating cavity.

According to at least one embodiment, the side of each sealing rubber strip in contact with the top plate and the bottom plate, and/or the side of each sealing rubber strip in contact with the side plate is provided with at least one protruding waterproof rib. The configuration of the waterproof rib can enhance the sealing performance and prevent liquid from entering the accommodating cavity.

According to at least one embodiment, at least one support column is arranged between the top plate and the bottom plate, and two ends of each support column are respectively connected with the top plate and the bottom plate.

According to at least one embodiment, the top plate and the bottom plate are both quadrilateral. Four side plates are provided, including a front plate, a rear plate, a left plate and a right plate which are independent from each other, and are respectively arranged corresponding to four sides of the top plate and the bottom plate. The four side plates and the top and bottom plates together form a hexahedral housing conforming to the universal shape of the base.

According to at least one embodiment, the positions where the left plate and the right plate attached to the top plate and the bottom plate are each provided with a thickened portion, the thickness of the thickened portion can be greater than or equal to 4 mm. With such configuration, it is convenient to mount the sealing rubber strip, and the left plate and the right plate can be attached to the top plate and the bottom plate more tightly and stably, without any random waggling.

According to at least one embodiment, the sealing rubber strip includes at least one waterproof strip and at least one waterproof ring. The waterproof strip is arranged at each top end and each bottom end of the left plate and the right plate respectively corresponding to the top plate and the bottom plate. The waterproof ring is arranged at the front plate and the rear plate corresponding to the left plate, the right plate, the top plate and the bottom plate. The end portion of the waterproof strip is abutted against the waterproof ring.

The sealing rubber strip according to the present invention is also divided into a plurality of portions corresponding to the plurality of side plates constituting the base. When making bases in different types, the plate not changed in size and the corresponding sealing rubber strip can remain in use, which increases versatility of the sealing rubber strip. As the positions where the left plate and the right plate are attached to the top plate and the bottom plate are in a long strip shape, the sealing rubber strip in such positions is waterproof strip which is in strip shape correspondingly. While the positions where the front plate and the rear plate are attached to the top plate and the bottom plate are in an irregular-shaped ring shape, the sealing rubber strip in such positions is waterproof ring which is in nearly ring shape correspondingly. The sealing rubber strip according to the present invention thus achieves a more reasonable design.

According to at least one embodiment, the top plate and the bottom plate are each provided with an accommodating groove corresponding to the waterproof strip, and/or the left plate and the right plate are provided with an accommodating groove corresponding to the waterproof strip. With such configuration, the waterproof strips 210 can be limited easily, which can avoid waggling randomly and changes in position to affect sealability of the base.

According to at least one embodiment, the front plate and the rear plate are each provided with an accommodating groove corresponding to the waterproof ring, which is served to receive the corresponding waterproof ring 220. With such configuration, the waterproof ring 220 can be limited easily, which can avoid waggling randomly and changes in position to affect sealability of the base.

According to at least one embodiment, the waterproof ring is provided with a positioning projection which is provided with a positioning hole, and the front plate and the rear plate are provided with a positioning post corresponding to the positioning hole. The positioning post is engaged with the positioning hole in the waterproof ring, so that the waterproof ring can be fixed more firmly without any random waggling.

In another aspect, a stage light fixture is provided, which includes the base mentioned above, a support arm pivoted to the base and a light head pivoted to the support arm. The light head includes a housing, a light source provided in the housing, a light emitting lens provided at a light outlet of the housing, and an effect assembly provided between the light source and the light emitting lens.

### BRIEF DESCRIPTION OF THE DRAWINGS

FIG. 1 is an exploded schematic diagram of a waterproof spliced base according to one embodiment.

FIG. 2 is an enlarged structural schematic diagram of a position A of FIG. 1.

FIG. 3 is a cross-sectional structural schematic diagram of the waterproof spliced base according to one embodiment.

FIG. 4 is a perspective view of a stage light fixture according to one embodiment.

### DETAILED DESCRIPTION

The accompanying drawings are for exemplary illustration only, and should not be construed as limitations on this patent; in order to better illustrate the present embodiment, some parts in the accompanying drawings may be omitted, enlarged or reduced, and they do not represent the size of the actual product; for those skilled in the art, it is understandable that certain well-known structures and descriptions thereof in the drawings may be omitted. The positional relationship described in the drawings is only for exemplary illustration, and should not be construed as limitations on this patent.

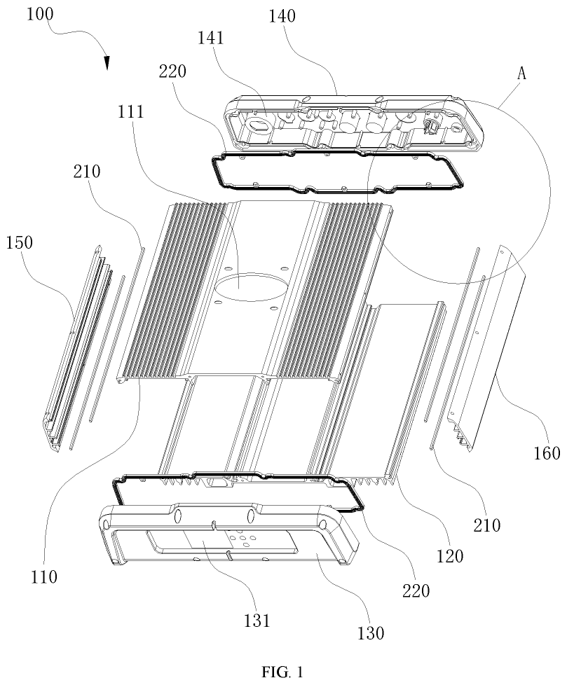

FIG. 1 provides a waterproof spliced base 100 according to at least one embodiment. The waterproof spliced base 100 includes a top plate 110 and a bottom plate 120 oppositely arranged, and a plurality of side plates arranged around the periphery of the bottom plate 120 and the top plate 110, so that the top plate 110, the bottom plate 120 and the side plates are spliced together to form an accommodating cavity for receiving electronic components. At least one sealing rubber strip for sealing the accommodating cavity is arranged between the side plates and the bottom plate 120 as well as between the side plates and the top plate 110. The top plate 110 is provided with a pivoting hole 111 for mounting a pivoting shaft of the stage light fixture.

The base 100 according to the present embodiment is spliced by the top plate 110, the bottom plate 120 and the plurality of side plates. Such configuration has advantages of convenience to disassemble and assemble and low manufacturing cost. Due to the splicing configuration, for base in different types, only components with size changed are required to be replaced, other components are in the existing designed specifications. For example, when bases with different height are in need, it is only required to change the height of the side plates, while changes for the top plate 110 and the bottom plate 120 are not necessary. Or when only changes for the length or width of the base 100 are in need, the side plates in the width or length direction can reuse. Therefore, the versatility of the components of the base 100 in such configuration is much higher, and the base 100 can be easily sealed with sealing rubber strips to ensure waterproof performance of the base.

It should be noted that the top plate 110, the bottom plate 120 and the side plates do not need to be completely in a flat plate shape, may also be plates with arc-shaped surfaces or raised outer side surfaces, or can also be in other special shapes. The splicing construction thus can obtain base 100 of the stage light fixture in richer shape.

In a preferred embodiment, at least one side plate is provided with a signal interface 141 for signal input and at least one side plate is provided with a display screen 131 for information display.

Optionally, the signal interface 141 is a CANNON interface.

In a preferred embodiment, the top plate 110, the bottom plate 120, and the side plates are in form of profile plates. That is, the plates are formed by extrusion-drawing, die-casting or injection molding, rather than formed by bending a thin metal plate. A profile configuration of the plate has high strength, can locally increase the thickness or perform modeling, and can be conveniently spliced with other components or engaged with other components.

The top plate 110, the bottom plate 120 and the side plates may be made of metal or plastics.

Optionally, the top plate 110, the bottom plate 120, and the side plates according to one embodiment are formed by a stretching process with aluminum material.

In a preferred embodiment, the side plates are fastened with the top plate 110 and the bottom plate 120 by screws. In order to avoid destroying sealability of the accommodating cavity, the screws are located outside the sealing rubber strips.

Optionally, the screws are screwed in the top plate 110 and the bottom plate 120 from the side plates. The corresponding screw holes in the top plate 110 and the bottom plate 120 are blind holes, avoiding destroying sealability of the accommodating cavity.

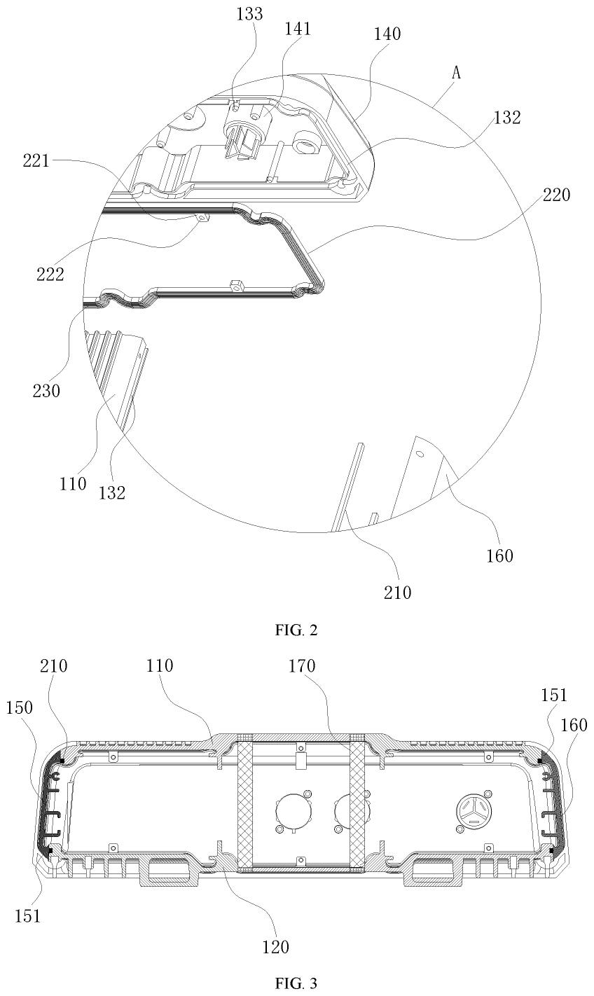

Referring to FIG. 2, in a preferred embodiment, the side of each sealing rubber strip in contact with the top plate 110 or the bottom plate 120, and/or the side of each sealing rubber strip in contact with the side plate is provided with at least one protruding waterproof rib 230. The waterproof rib 230 extends in the length or perimeter direction of the sealing rubber strip. The configuration of the waterproof rib 230 can enhance the sealing performance and prevent liquid from entering the accommodating cavity.

As shown in FIG. 2, the number of the waterproof ribs 230 in the present embodiment is greater than or equal to 3.

Referring to FIG. 3, in a preferred embodiment, at least one support column 170 is arranged between the top plate 110 and the bottom plate 120. Two ends of each support column 170 are respectively connected with the top plate 110 and the bottom plate 120. The configuration of the support column 170 connecting the top plate 110 and the bottom plate 120 can enhance the strength of the whole base 100. In case that the base 100 is hung up, the support column 170 will guide the pulling force of the support arm on the top plate 110 to the bottom plate 120 and finally guide the pulling force onto a hanging assembly.

Optionally, the number of the support columns 170 is greater than or equal to three, and the support columns are arranged around the pivoting hole 111. In the present embodiment, four support columns 170 are provided.

It should be noted that in the case a plurality of side plates are provided, the top plate 110 and the bottom plate 120 are polygons with a number of sides corresponding to the number of the side plates. For example, if the number of the side plates is six or eight, the top plate 110 and the bottom plate 120 are a hexagon or an octagon.

Referring to FIG. 1, in a preferred embodiment, the top plate 110 and the bottom plate 120 are both quadrilateral. The number of the side plates is four, including a front plate 130, a rear plate 140, a left plate 150 and a right plate 160 which are independent from each other, and are respectively arranged corresponding to four sides of the top plate 110 and the bottom plate 120. The four side plates and the top and bottom plates together form a hexahedral housing which conforms to the universal shape of the base 100. When only the length of one group of opposite sides of the top plate 110 and the bottom plate 120 changes, the side plates corresponding to the other group of opposite sides may remain in use, or the height of the front plate 130, the rear plate 140, the left plate 150 and the right plate 160 is increased to increase the overall height of the base 100, the top plate 110 and the bottom plate 120 can remain in use. Therefor universality of the components of the base 100 can be achieved.

Optionally, the top plate 110 and the bottom plate 120 are both rectangular.

Optionally, the signal interface 141 is located on the rear plate 140 and the display screen 131 is located on the front plate 130.

Referring back to FIG. 2 and FIG. 3, in a preferred embodiment, the positions where the left plate 150 and the right plate 160 attached to the top plate 110 and the bottom plate 120 are each provided with a thickened portion 150. The thickness of the thickened portion 151 is greater than or equal to 4 mm. Such configuration is convenient to mount the sealing rubber strip, and ensures that the left plate 150 and the right plate 160 are attached to the top plate 110 and the bottom plate 120 more tightly and stably, without random waggling.

Optionally, the thickened portion 151 is integrally formed with the left plate 150 and the right plate 160, instead of being fixed by splicing.

In a preferred embodiment, each sealing rubber strip includes at least one waterproof strip 210 and at least one waterproof ring 220. The waterproof strip 210 is arranged at each top end and each bottom end of the left plate 150 and the right plate 160 respectively corresponding to the top plate 110 and the bottom plate 120. The waterproof ring 220 is arranged at the front plate 130 and the rear plate 140 corresponding to the left plate 150, the right plate 160, the top plate 110 and the bottom plate 120. The end portion of the waterproof strip 210 is abutted against the waterproof ring 220. According to the present embodiment, the sealing rubber strip is also divided into a plurality of portions corresponding to the plurality of side plates forming the base 100. When making bases 100 in different types, the plate not changed in size and the corresponding sealing rubber strip can remain in use, thus increasing versatility of the sealing rubber strip. As the positions where the left plate 150 and the right plate 160 are attached to the top plate 110 and the bottom plate 120 are in a long strip shape, the sealing rubber strip in such positions thus is waterproof strip 210 which is in strip shape correspondingly. While the positions where the front plate 130 and the rear plate 140 are attached to the top plate 110 and the bottom plate 120 are in an irregular-shaped ring shape, the sealing rubber strip in such positions thus is waterproof ring which is in nearly ring shape correspondingly. Accordingly, the sealing rubber strip according to the present embodiment thus achieves a more reasonable design.

In the present embodiment, the screws on the front plate 130 and the rear plate 140 are located away from the waterproof rings 220, and the screws on the left plate 150 and the right plate 160 are located on the sides of the waterproof strips 210 away from each other.

In a preferred embodiment, the top plate 110 and the bottom plate 120 are each provided with an accommodating groove 132 corresponding to the waterproof strip 210, which is served to receive the corresponding waterproof strip 210. The left plate 150 and the right plate 160 each are also provided with an accommodating groove 132 corresponding to the waterproof strip 210. With such configuration, the waterproof strips 210 can be limited easily, which can avoid waggling randomly and changes in position to affect sealability of the base 100.

Optionally, each waterproof strip 210 protrudes out of the accommodating groove 132 by 0.3-0.7 mm.

In a preferred embodiment, the front plate 130 and the rear plate 140 are each provided with an accommodating groove 132 corresponding to the waterproof ring 220, which is served to receive the corresponding waterproof ring 220. With such configuration, the waterproof rings 220 can be limited easily, which can avoid waggling randomly and changes in position to affect sealability of the base 100.

Optionally, each waterproof ring 220 protrudes out of the accommodating groove 132 by 0.3-0.7 mm.

In a preferred embodiment, each waterproof ring 220 is provided with a positioning projection which is provided with a positioning hole. Correspondingly, the front plate 130 and the rear plate 140 are each provided with a positioning post 133. The positioning post 133 is engaged with the positioning hole in the waterproof ring, so that the waterproof ring can be fixed more firmly without any random waggling.

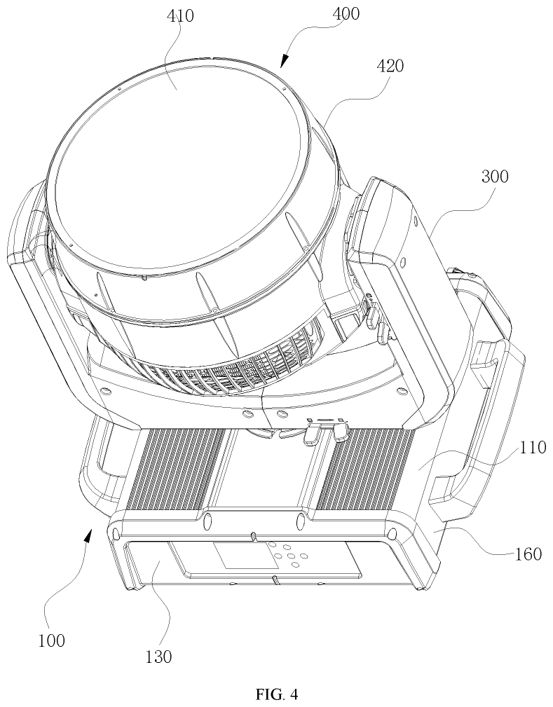

FIG. 4 provides a stage light fixture according to one embodiment, which includes a waterproof spliced base 100 as mentioned above, a support arm 300 pivoted to the base 100, and a light head 400 pivoted to the support arm 300. The light head 400 includes a housing 420, a light source located in the housing 420, a light emitting lens 410 located at a light outlet of the housing 420, and an effect assembly located between the light source and the light emitting lens 410.

The effect assembly can be one or more of a CMY color mixer, a color temperature wheel, a fire wheel, a fixed pattern gobo, a rotating pattern gobo, a color wheel, a prism, a frosting mirror, etc

Obviously, the above-mentioned embodiments of the present invention are only examples for clearly illustrating the present invention, rather than limiting the implementation modes of the present invention. For those of ordinary skill in the art, changes or modifications in other different forms can also be made on the basis of the above description. It is not needed and it is impossible to list all implementation modes here. Any modifications, equivalent replacements and improvements made within the spirit and principles of the present invention shall be included within the protection scope of the claims of the present invention.

1. A waterproof spliced base for a stage light fixture, comprising
a top plate and a bottom plate oppositely arranged, and a plurality of side plates arranged around a periphery of the bottom plate and the top plate, the top plate, the bottom plate and the plurality of the side plates being spliced to form an accommodating cavity for accommodating electronic components,
wherein at least one sealing rubber strip for sealing the accommodating cavity are arranged between the plurality of the side plates and the bottom plate as well as between the plurality of the side plates and the top plate, and
the top plate is provided with a pivoting hole for mounting a pivoting shaft of the stage light fixture.

2. The waterproof spliced base according to claim 1, wherein at least one side plate is provided with a signal interface and at least one side plate is provided with a display screen.

3. The waterproof spliced base according to claim 1, wherein the top plate, the bottom plate and the plurality of the side plates are all in form of profile plates.

4. The waterproof spliced base according to claim 1, wherein the plurality of the side plates are fastened with the top plate and the bottom plate by screws, the screws are located outside the sealing rubber strip.

5. The waterproof spliced base according to claim 1, wherein a side of each sealing rubber strip in contact with the top plate and the bottom plate, or a side of each sealing rubber strip in contact with the side plate is provided with at least one protruding waterproof rib.

6. The waterproof spliced base according to claim 1, wherein at least one support column is arranged between the top plate and the bottom plate, and two ends of each support column are respectively connected with the top plate and the bottom plate.

7. The waterproof spliced base according to claim 1, wherein the top plate and the bottom plate are both quadrilateral, four side plates are provided, including a front plate, a rear plate, a left plate and a right plate which are independent from each other, and are respectively arranged corresponding to four sides of the top plate and the bottom plate.

8. The waterproof spliced base according to claim 7, wherein positions where the left plate and the right plate attached to the top plate and the bottom plate are each provided with a thickened portion, a thickness of the thickened portion is greater than or equal to 4 mm.

9. The waterproof spliced base according to claim 7, wherein the sealing rubber strip comprises
at least one waterproof strip arranged at each top end and each bottom end of the left plate and the right plate respectively corresponding to the top plate and the bottom plate, and
at least one waterproof ring arranged at the front plate and the rear plate corresponding to the left plate, the right plate, the top plate and the bottom plate, and an end portion of the waterproof strip is abutted against the waterproof ring.

10. The waterproof spliced base according to claim 9, wherein the top plate and the bottom plate are each provided with an accommodating groove corresponding to the waterproof strip, or the left plate and the right plate are each provided with an accommodating groove corresponding to the waterproof strip.

11. The waterproof spliced base with the spliced waterproof chassis according to claim 9, wherein the front plate and the rear plate are each provided with an accommodating groove corresponding to the waterproof ring.

12. The waterproof spliced base according to claim 9, wherein each waterproof ring is provided with a positioning projection, the positioning projection is provided with a positioning hole, and the front plate and the rear plate are each provided with a positioning post corresponding to the positioning hole.

13. A stage light fixture, comprising
the waterproof spliced base according to claim 1,
a support arm pivoted to the waterproof spliced base, and
a light head pivoted to the support arm, the light head includes a housing, a light source provided in the housing, a light emitting lens provided at a light outlet of the housing, and an effect assembly provided between the light source and the light emitting lens.
